(19) United States
(12) Patent Application Publication
(10) Pub. No.: US 2012/0155875 A1
(43) Pub. Date: Jun. 21, 2012

(54) OPTICAL RECEIVER

(75) Inventor: Jong-Hoi KIM, Daejeon (KR)

(73) Assignee: ELECTRONICS AND TELECOMMUNICATIONS RESEARCH INSTITUTE, Daejeon (KR)

(21) Appl. No.: 13/301,816

(22) Filed: Nov. 22, 2011

(30) Foreign Application Priority Data
Dec. 17, 2010 (KR) 10-2010-0129932

(51) Int. Cl. H04J 14/06

(52) U.S. Cl. 398/65

(57) ABSTRACT

Disclosed is an optical receiver including: a polarization splitter splitting two polarization components perpendicular to each other from an optical signal to output a first polarization signal and a second polarization signal; a first optical delay splitter and a second optical delay splitter branching each polarization signal to output two branch signals, respectively; a first optical hybrid and a second optical hybrid each outputting four interference signals in which a phase shift increases by each 90° by using the two branch signals; and four photo detectors each outputting a differential signal between two interference signals in which the phase shift is 180° .

### CROSS-REFERENCE TO RELATED APPLICATIONS

This application is based on and claims priority from Korean Patent Application No. 10-2010-0129932, filed on Dec. 17, 2010, with the Korean Intellectual Property Office, the present disclosure of which is incorporated herein in its entirety by reference.

### TECHNICAL FIELD

The present disclosure relates to an optical receiver used in a polarization division multiplexing based multilevel differential phase shift keying (DPSK) optical communication system, and more particularly, to an optical receiver that separates polarization components perpendicular to each other from optical signals transferring different information in a phase modulation method and demodulates the polarization components.

### BACKGROUND

Examples of an optical receiver for a phase modulation type optical communication system in the related art include an optical receiver for a coherent optical communication system demodulating a phase by using a local oscillator (LO) and an optical receiver for a multilevel differential phase shift keying type optical communication system that does not need the LO.

In recent years, an optical communication system technology adopting a polarization division multiplexing method capable of mitigating a signal processing velocity of core components such as an photo detector, an analog to digital converter (ADC), and a digital signal processor (DSP) required to configure the system by decreasing a channel transmission velocity through sharing of a channel capacity by two polarization components, has been developed.

Since the multilevel DPSK type optical receiver does not need the LO, the multilevel DPSK type optical receiver can simplify the system and since the polarization division multiplexing type optical receiver mitigates the signal processing velocity of the components, the polarization division multiplexing type optical receiver can lower a system price by using relatively low-priced components.

Accordingly, when an optical receiver in which the polarization division multiplexing type and the multilevel DPSK type are coupled with each other, is provided, the system can be simplified and it is advantageous in terms of price.

### SUMMARY

The present disclosure has been made in an effort to provide a polarization division multiplexing based multilevel DPSK optical receiver that can separate polarization, generate a optical delay signal, and demodulate a phase of a signal without using an LO.

An exemplary embodiment of the present disclosure provides an optical receiver including: a polarization splitter splitting two polarization components perpendicular to each other from an optical signal to output a first polarization signal and a second polarization signal; a first optical delay splitter and a second optical delay splitter branching each polarization signal to output two branch signals, respectively; a first optical hybrid and a second optical hybrid each outputting four interference signals in which a phase shift increases by each 90° by using the two branch signals; and four photo detectors each outputting a differential signal between two interference signals in which the phase shift is 180°.

According to an exemplary embodiment of the present disclosure, by providing a polarization division multiplexing based multilevel DPSK optical receiver, it is possible to simplify a system structure because an LO for phase demodulation is not required and lower the price of components by mitigating processing velocities of indispensable components required for the system with respect to a phase modulation type optical communication system for superhigh-speed and large-capacity optical transmission.

Further, by providing the polarization division multiplexing based multilevel DPSK optical receiver in which a polarization splitter, a optical delay splitter, an optical hybrid, and an photo detector are integrated in a single substrate, it is possible to miniaturize the optical receiver and save a production cost of the optical receiver, thereby lowering the price of the polarization division multiplexing based multilevel DPSK optical receiver.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing an internal schematic configuration of an optical receiver according to a first exemplary embodiment of the present disclosure.

FIG. 2 is a diagram showing an internal schematic configuration of an optical receiver according to a second exemplary embodiment of the present disclosure.

FIG. 3 is a diagram showing an internal schematic configuration of an optical receiver according to a third exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

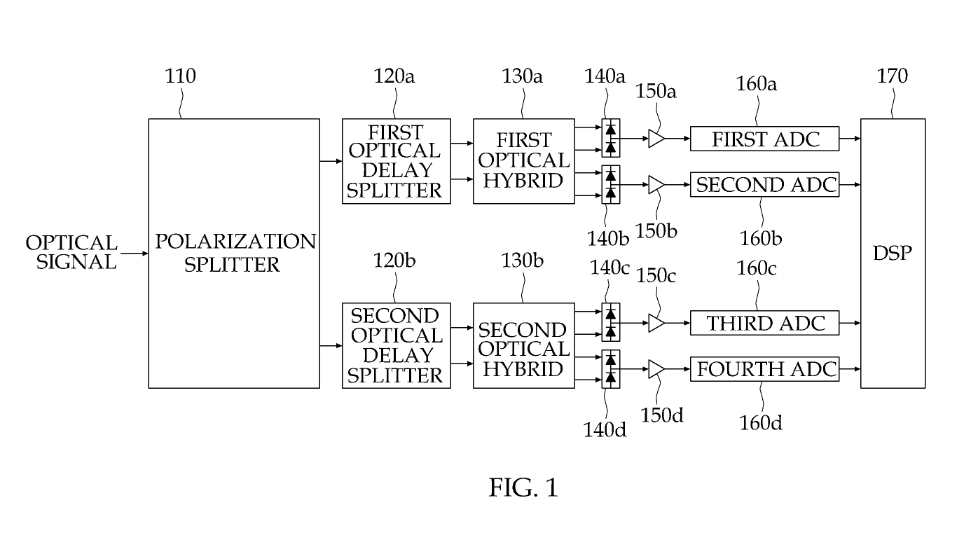

FIG. 1 is a diagram showing an internal schematic configuration of an optical receiver according to a first exemplary embodiment of the present disclosure.

Referring to FIG. 1, the optical receiver according to the first exemplary embodiment of the present disclosure includes: a polarization splitter 110, a first optical delay splitter 120a, a second optical delay splitter 120b, a first optical hybrid 130a, a second optical hybrid 130b, four photo detectors 140a, 140b, 140c, and 140d, four transimpedance amplifiers (hereinafter, referred to as ‘TIA’) 150a, 150b, 150c, and 150d, four analog to digital converters (hereinafter, referred to as ‘ADC’) 160a, 160b, 160c, and 160d, and a digital signal processor (hereinafter referred to as ‘DSP’) 170.

Polarization splitter 110 splits two polarization components perpendicular to each other from an optical signal to output a first polarization signal and a second polarization signal.

First optical delay splitter 120a branches the first polarization signal to output a first branch signal and a second branch signal delayed from the first branch signal by 1 bit and second optical delay splitter 120b branches the second polarization signal to output a third branch signal and a fourth branch signal delayed from the third branch signal by 1 bit.

First optical hybrid 130a outputs four interference signals in which a phase shift increases by 90° by using the first branch signal and the second branch signal outputted from first optical delay splitter 120a and second optical hybrid 130b outputs four interference signals in which the phase shift increases by 90° by using the third branch signal and the fourth branch signal outputted from second optical delay splitter 120b.

Four photo detectors 140a, 140b, 140c, and 140d output a differential signal between two interference signals in which the phase shift is 180°.

Each of four TIAs 150a, 150b, 150c, and 150d amplifies the differential signal outputted from the photo detector to output the amplified signal.

Each of four ADCs 160a, 160b, 160c, and 160d converts the amplified signal outputted from each TIA to output a digital signal.

DSP 170 demodulates phases of the first and second polarization signals by using the digital signals outputted from four ADCs 160a, 160b, 160c, and 160d.

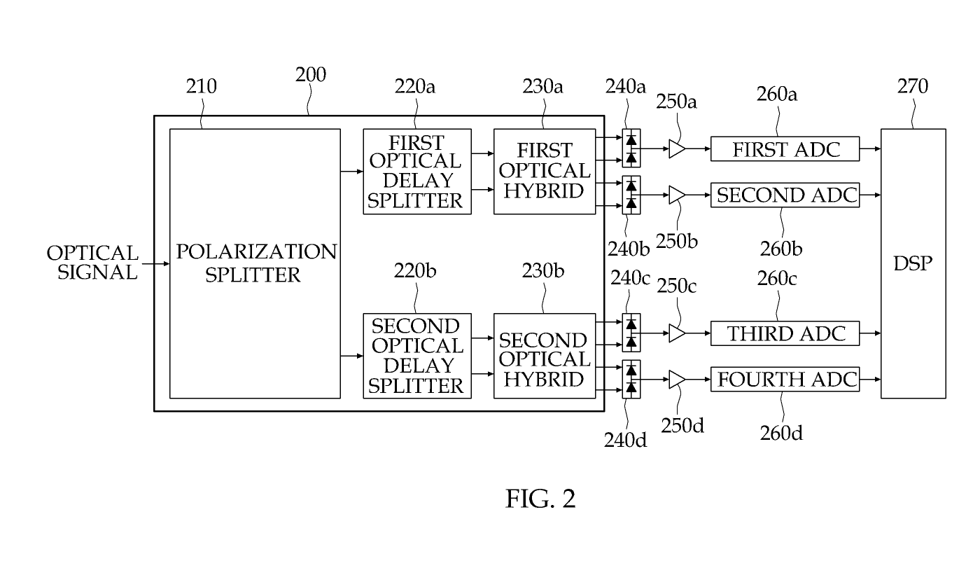

FIG. 2 is a diagram showing an internal schematic configuration of an optical receiver according to a second exemplary embodiment of the present disclosure.

Referring to FIG. 2, the optical receiver according to the second exemplary embodiment of the present disclosure includes: a polarization splitter 210, a first optical delay splitter 220a, a second optical delay splitter 220b, a first optical hybrid 230a, a second optical hybrid 230b, four photo detectors 240a, 240b, 240c, and 240d, four TIAs 250a, 250b, 250c, and 250d, four ADCs 260a, 260b, 260c, and 260d, and a DSP 270. Herein, since the components constituting the optical receiver are the same as those of the optical receiver of FIG. 1, a detailed description thereof will be omitted.

However, in the optical receiver according to the second exemplary embodiment of the present disclosure, polarization splitter 210, first optical delay splitter 220a, second optical delay splitter 220b, first optical hybrid 230a, and second optical hybrid 230b are formed on the same waveguide layer of a single substrate to constitute an optical demodulator 200.

However, in the optical receiver according to the second exemplary embodiment of the present disclosure, polarization splitter 210, first optical delay splitter 220a, second optical delay splitter 220b, first optical hybrid 230a, and second optical hybrid 230b are integrated in the single substrate to miniaturize the optical receiver and save a production cost of the optical receiver.

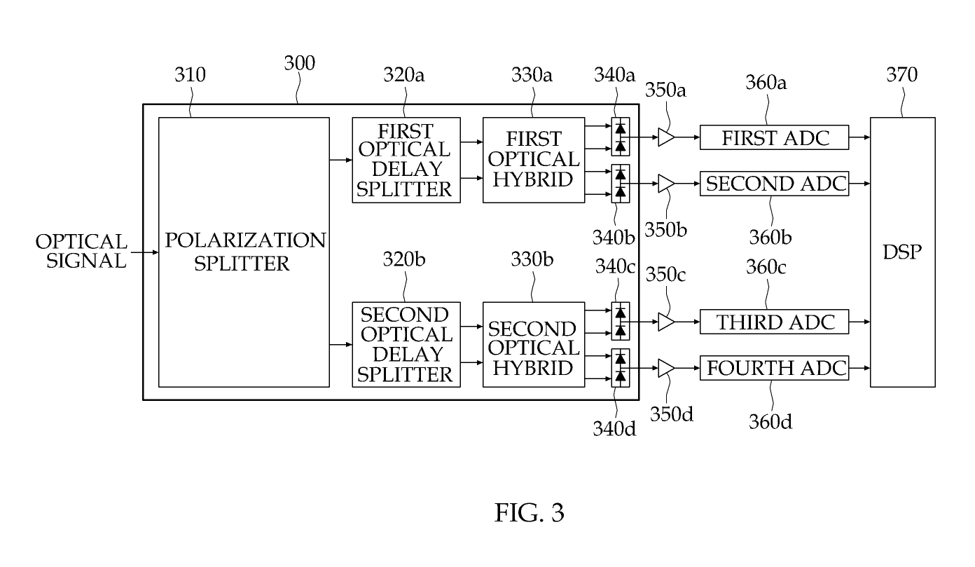

FIG. 3 is a diagram showing an internal schematic configuration of an optical receiver according to a third exemplary embodiment of the present disclosure.

Referring to FIG. 3, the optical receiver according to the third exemplary embodiment of the present disclosure includes: a polarization splitter 310, a first optical delay splitter 320a, a second optical delay splitter 320b, a first optical hybrid 330a, a second optical hybrid 330b, four photo detectors 340a, 340b, 340c, and 340d, four TIAs 350a, 350b, 350c, and 350d, four ADCs 360a, 360b, 360c, and 360d, and a DSP 370. Herein, since the components constituting the optical receiver are the same as those of the optical receiver of FIG. 1, a detailed description thereof will be omitted.

However, in the optical receiver according to the third exemplary embodiment of the present disclosure, polarization splitter 310, first optical delay splitter 320a, second optical delay splitter 320b, first optical hybrid 330a, second optical hybrid 330b, and four photo detectors 340a, 340b, 340c, and 340d are formed on the same waveguide layer of a single substrate to constitute an optical demodulation detector 300.

Accordingly, in the optical receiver according to the third exemplary embodiment of the present disclosure, polarization splitter 310, first optical delay splitter 320a, second optical delay splitter 320b, first optical hybrid 330a, second optical hybrid 330b, and four photo detectors 340a, 340b, 340c, and 340d are formed on the single substrate to miniaturize the optical receiver and save a production cost of the optical receiver.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An optical receiver, comprising:
a polarization splitter splitting two polarization components perpendicular to each other from an optical signal to output a first polarization signal and a second polarization signal;
a first optical delay splitter and a second optical delay splitter branching each polarization signal to output two branch signals, respectively;
a first optical hybrid and a second optical hybrid each outputting four interference signals in which a phase shift increases by each 90° by using the two branch signals; and
four photo detectors each outputting a differential signal between two interference signals in which the phase shift is 180°.

2. The optical receiver of claim 1, wherein:
the first optical delay splitter branches the first polarization signal to output a first branch signal and a second branch signal delayed from the first branch signal by 1 bit, and
the second optical delay splitter branches the second polarization signal to output a third branch signal and a fourth branch signal delayed from the third branch signal by 1 bit.

3. The optical receiver of claim 2, wherein:
the first optical hybrid outputs four interference signals in which the phase shift increases by each 90° by using the first branch signal and the second branch signal, and the second optical hybrid outputs four interference signals in which the phase shift increases by each 90° by using the third branch signal and the fourth branch signal.

4. The optical receiver of claim 1, further comprising:
four transimpedance amplifiers each amplifying the differential signal outputted from the photo detector to output the amplified signal;
four analog to digital converters each converting the amplified signal outputted from each transimpedance amplifier to output a digital signal; and
a digital signal processor demodulating phases of the first polarization signal and the second polarization signal by using the digital signals outputted from four analog to digital converters.

5. The optical receiver of claim 1, wherein the polarization splitter, the first optical delay splitter, the second optical delay splitter, the first optical hybrid, and the second optical hybrid are formed on the same waveguide layer of a single substrate to constitute an optical demodulator.

6. The optical receiver of claim 1, wherein the polarization splitter, the first optical delay splitter, the second optical delay splitter, the first optical hybrid, the second optical hybrid, and the four photo detectors are formed on the same waveguide layer of a single substrate to constitute an optical demodulation detector.
